(19) United States
(12) Patent Application Publication
(10) Pub. No.: US 2006/0045110 A1
(43) Pub. Date: Mar. 2, 2006

(54) Information distribution system, terminal device, information distribution server, information distribution method, terminal device connection method, information processing program product, and storage medium

(76) Inventors: Takayuki Miura, Tokyo (JP); Naoshi Suzuki, Chiba (JP)

Correspondence Address: BELL, BOYD & LLOYD, LLC, P. O. BOX 1135, CHICAGO, IL, 60690-1135, US

(21) Appl. No.: 11/197,007

(22) Filed: Aug. 4, 2005

(30) Foreign Application Priority Data
Aug. 27, 2004 (JP) P2004-248796

(51) Int. Cl. H04L 12/28

(52) U.S. Cl. 370/408

(57) ABSTRACT

An information distribution system, a terminal device, an information distribution server, an information distribution server, an information distribution method, a terminal device connection method, an information processing program product, and a storage medium are provided. An information distribution system with a tree-structure network includes an information distribution server placed in a root node and terminal devices placed in nodes below the root node. Bidirectional communication can be always performed between the nodes. When a terminal device sends a request for information to be distributed from the information distribution server, each of the terminal devices constituting the information distribution system transfers the request to an adjacent node, the request transfer being performed from the requesting terminal device to a storage node storing the information, and transfers to an adjacent node the information supplied from the storage node, the information transfer being performed from the storage node to the requesting terminal device, in response to the transferred request. The requesting terminal device stores the transferred information.

### CROSS REFERENCES TO RELATED APPLICATIONS

The present application claims priority to Japanese Patent Application No. 2004-248796 filed in the Japan Patent Office on Aug. 27, 2004, the entire contents of which being incorporated herein by reference.

### BACKGROUND

The present invention relates to information distribution systems, terminal devices, information distribution servers, information distribution methods, terminal device connection methods, information processing program products, and storage media, and more particularly, to reducing an information transmission load on an information distribution server by sending and receiving information distributed from the information distribution server between terminal devices.

In recent years, due to the wide use of communication networks, such as the Internet, consumer electronics (CE) devices have become commonplace.

CE devices are terminal devices, such as audio-visual devices (including video cassette recorders, stereos, and television sets), home electric appliances (including rice cockers and refrigerators), or other electronic devices, that contain a computer having a network connection function. CE devices are capable of providing services via networks.

For example, by accessing servers using cellular phones, users of such CE devices are able to set recording reservations for video cassette recorders located at home via networks or set air conditioners located at home.

In addition, users are able to download movie content or music content to television receivers or stereos to play back the movie content or the music content. In addition, users are able to download game content to game machines to play the game.

It is desirable that digital information (content, software, computer programs, and information constituted by other types of digital information) stored in CE devices be updated when necessary. Such updating is performed by information distribution servers distributing data information and digital information via networks.

Data information includes a list of digital information that can be distributed from an information distribution server. For example, data information includes information for confirming the content of the digital information, such as a digital information identifier, a title, version information, and the like.

Each CE device acquires data information from an information distribution server, determines necessary digital information in accordance with the data information, and requires the information distribution server to send the necessary digital information.

Information distribution systems in which an information distribution server distributes digital information via a network, as described above, are categorized into a pull-type information distribution system and a push-type information distribution system. In the pull-type information distribution system, a CE device voluntarily polls the information distribution server to confirm the existence or absence of data information. In the push-type information distribution system, the information distribution server sends data information to the CE device.

For the push-type information distribution system, since means for reporting data information to all the client terminals, that is, CE devices, is not established in IP networks, a pseudo-push-type information distribution system using a polling procedure is used.

For example, a technology for providing a service to update digital information in a terminal device is available, as described in Japanese Unexamined Patent Application Publication No. 9-190353.

In this technology, a communication administration center establishes a communication line to a radio communication terminal, such as a cellular phone, and sends an update program.

In a known network structure, each CE device polls an information distribution server, as shown in FIG. 12. Thus, the load on the information distribution server increases in proportion to an increase in the number of CE devices.

Although a longer polling interval can be set in order to reduce the load on the information distribution server, a longer polling interval reduces the speed of reporting digital information to the CE devices and thus reduces the freshness of the digital information supplied to the CE devices.

In particular, when software updating or download sales of new game software begins, too much access is provided to an information distribution server. Thus, distributing fresh digital information to CE devices while the load on the information distribution server is reduced during this period is an important issue.

### SUMMARY

It is desirable to reduce the load on an information distribution server while the immediacy of information supply to a terminal device is ensured.

According to an embodiment of the present invention, an information distribution system with a tree-structure network includes an information distribution server placed in a root node; and terminal devices placed in nodes below the root node. Bidirectional communication can be always performed between the nodes. When a terminal device sends a request for information to be distributed from the information distribution server, each of the terminal devices constituting the information distribution system transfers the request to an adjacent node, the request transfer being performed from the requesting terminal device to a storage node storing the information, and transfers to an adjacent node the information supplied from the storage node, the information transfer being performed from the storage node to the requesting terminal device, in response to the transferred request. The requesting terminal device stores the transferred information.

According to an embodiment of the present invention, a terminal device used in an information distribution system with a tree-structure network in which an information distribution server is placed in a root node and in which terminal devices are placed in nodes below the root node includes connection means for connecting to a node immediately above and to a node immediately below so as to always perform bidirectional communication; and information storage means for storing information distributed via the network.

The terminal device may further include list receiving means for receiving from the node immediately above, connected by the connection means, a list of information to be distributed from the information distribution server; and list sending means for sending the received list to the node immediately below, connected by the connection means.

The terminal device may further include request reception means for receiving from the node immediately below, connected by the connection means, a request for information; and information sending means for reading from the information storage means the information for which the request is received and for sending the read information to the node immediately below.

The terminal device may further include information request means for sending the request for the information to the node immediately above, connected by the connection means, when the information storage means does not store the information. The information sending means may send to the node immediately below the information sent from the node immediately above in response to the request.

The terminal device may further include access information acquisition means for acquiring access information for accessing another terminal device serving as a node; and mutual authentication means for accessing the other terminal device using the acquired access information and for mutually performing device authentication with the other terminal device. After mutual authentication is performed, the connection means may connect the terminal device, as a node immediately below the other terminal device, to the other terminal device.

When the other terminal device serving as the node immediately above loses a node functionality, the access information acquisition means may acquire the access information from the information distribution server.

The terminal device may further include mutual authentication means for receiving access from a terminal device that does not serve as a node and for mutually performing device authentication with the terminal device that does not serve as the node. After mutual authentication is performed, the connection means may connect the terminal device, as a node immediately above the terminal device that does not serve as the node, to the terminal device that does not serve as the node.

In a case where the number of currently connected nodes reaches an upper limit, the terminal device may send access information on access to a terminal device serving as the node immediately below to the terminal device that does not serve as the node when receiving access from the terminal device that does not serve as the node.

According to an embodiment of the present invention, an information distribution server used in an information distribution system with a tree-structure network in which the information distribution server is placed in a root node and in which terminal devices are placed in nodes below the root node includes connection means for connecting to a terminal device serving as a node immediately below so as to always perform bidirectional communication; list sending means for sending a list of information to be distributed via the network to the terminal device serving as the node immediately below; request reception means for receiving a request for information included in the list from the terminal device serving as the node immediately below; and information sending means for sending the information for which the request is received to the terminal device serving as the node immediately below.

The information distribution server may further include access information request reception means for receiving an access information request for access information from a terminal device that does not serve as a node; and access information sending means for sending the access information on access to the terminal device serving as the node immediately below to the terminal device that does not serve as the node in response to the access information request.

The information distribution server may further include device type information acquisition means for acquiring device type information of the terminal device that does not serve as the node. The access information sending means may select access information to be sent to the terminal device that does not serve as the node in accordance with the acquired device type information.

According to an embodiment of the present invention, an information distribution method performed by a terminal device that is used in an information distribution system with a tree-structure network in which an information distribution server is placed in a root node and in which terminal devices are placed in nodes below the root node and that includes connection means for connecting to a node immediately above and to a node immediately below so as to always perform bidirectional communication, information storage means for storing information distributed via the network, request reception means, and information sending means includes the steps of receiving, by the request reception means, a request for information from the node immediately below, connected by the connection means; and sending, by the information sending means, the information for which the request is received, which is read from the information storage means, to the node immediately below.

According to an embodiment of the present invention, a terminal device connection method for connecting a terminal device that includes connection means for connecting to a node immediately above and to a node immediately below so as to always perform bidirectional communication and mutual authentication means to an information distribution system with a tree-structure network in which an information distribution server is placed in a root node and in which terminal devices are placed in nodes below the root node includes the steps of mutually performing, by the mutual authentication means, device authentication with a terminal device that does not serve as a node after receiving access from the terminal device that does not serve as the node; and connecting, by the connection means, the terminal device, as a node immediately above the terminal device that does not serve as the node, to the terminal device that does not serve as the node after mutual authentication is performed.

According to an embodiment of the present invention, an information distribution method performed by an information distribution server that is used in an information distribution system with a tree-structure network in which the information distribution server is placed in a root node and in which terminal devices are placed in nodes below the root node and that includes connection means for connecting to a terminal device serving as a node immediately below so as to always perform bidirectional communication, list sending means, request reception means, and information sending means includes the steps of sending, by the list sending means, a list of information to be distributed via the network to the terminal device serving as the node immediately below; receiving, by the request reception means, a request for information included in the list from the terminal device serving as the node immediately below; and sending, by the information sending means, the information for which the request is received to the terminal device serving as the node immediately below.

According to an embodiment of the present invention, an information processing program product executed by a computer constituting a terminal device in an information distribution system with a tree-structure network in which an information distribution server is placed in a root node and in which terminal devices are placed in nodes below the root node includes a connection function to connect to a node immediately above and to a node immediately below so as to always perform bidirectional communication; and an information storage function to store information distributed via the network.

According to an embodiment of the present invention, an information processing program product executed by a computer constituting an information distribution server in an information distribution system with a tree-structure network in which the information distribution server is placed in a root node and in which terminal devices are placed in nodes below the root node includes a connection function to connect to a terminal device serving as a node immediately below so as to always perform bidirectional communication; a list sending function to send a list of information to be distributed via the network to the terminal device serving as the node immediately below; a request reception function to receive a request for information included in the list from the terminal device serving as the node immediately below; and an information sending function to send the information for which the request is received to the terminal device serving as the node immediately below.

Accordingly, the load on an information distribution server can be reduced while the immediacy of information supply to a terminal device is ensured.

Additional features and advantages are described herein, and will be apparent from, the following Detailed Description and the figures.

### BRIEF DESCRIPTION OF THE FIGURES

FIG. 1 shows the network structure of an information distribution system according to an embodiment of the present invention.

FIG. 2 is an illustration for explaining ports of a CE device.

FIG. 3 is an illustration for explaining distribution of data information.

FIG. 4 is an illustration for explaining distribution of digital information.

FIG. 5 is a flowchart showing a process for distributing the digital information from the information distribution system to the CE device.

FIG. 6 is a flowchart showing a process for connecting a new CE device to the information distribution system.

FIG. 7 is a flowchart showing a process for performing mutual authentication between CE devices.

FIG. 8 is a flowchart showing another process for performing mutual authentication between the CE devices.

FIG. 9 is an illustration for explaining a recovery procedure when a CE device is disconnected from the information distribution system.

FIG. 10 is an illustration for explaining an information distribution system according to a modification of the present invention.

FIG. 11 shows the hardware structure of a CE device.

FIG. 12 shows the network structure of a known information distribution system.

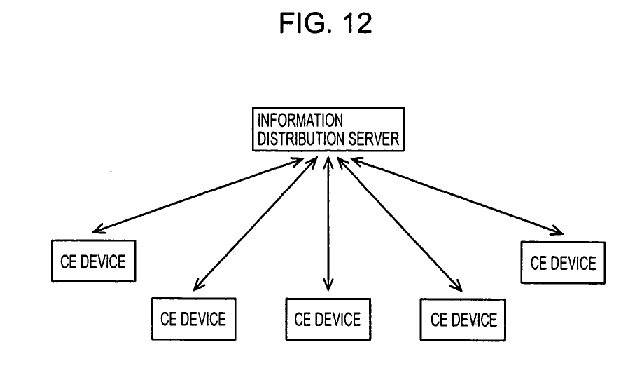

### DETAILED DESCRIPTION

The present invention relates to information distribution systems, terminal devices, information distribution servers, information distribution methods, terminal device connection methods, information processing program products, and storage media, and more particularly, to reducing an information transmission load on an information distribution server by sending and receiving information distributed from the information distribution server between terminal devices.

In an embodiment of the present invention, the network of an information distribution system has a tree structure. An information distribution server serves as a root node, and CE devices serve as nodes below the root node.

Concerning distribution of data information, data information is distributed, based on relay transfer, from the information distribution server to a terminal device serving as an end node.

In other words, first, the information distribution server sends data information to a CE device serving as a node immediately below the information distribution server. After receiving the data information, the CE device transfers the data information to a CE device serving as a node immediately below the CE device. Then, reception and transfer of the data information is repeated until the data information is transmitted to a CE device serving as an end node of the tree structure.

Thus, the information distribution server is capable of distributing the data information to all the CE devices only by sending the data information to the CE device serving as the node immediately below.

After receiving data information, a CE device determines, in accordance with the received data information, whether or not necessary digital information is included in digital information that can be distributed from the information distribution server.

If necessary digital information exists, the CE device requires a CE device serving as the node immediately above to send the digital information.

After receiving the request, the requested CE device determines whether or not the requested CE device stores the digital information. If the requested CE device stores the digital information, the requested CE device sends the digital information to the requesting CE device immediately below.

If the requested CE device does not store the digital information, the requested CE device requires a CE device serving as the node immediately above to send the digital information.

Subsequently, such a request to a node immediately above is repeated until a node storing the digital information is found.

Then, when such a request is sent to a node storing the digital information, the digital information is transferred from this node to the originally requesting CE device by tracking back the path through which the request was transferred.

As described above, in the information distribution system according to the embodiment of the present invention, data information is distributed, based on top-down transfer, from the information distribution server to all the CE devices.

A request for digital information is transferred from a requesting CE device to a node storing the digital information by relaying CE devices serving as nodes between the requesting CE device and the node storing the digital information. In addition, the digital information is transferred from the node storing the digital information to the originally requesting CE device by relaying the CE devices serving as the nodes between the node storing the digital information and the originally requesting CE device.

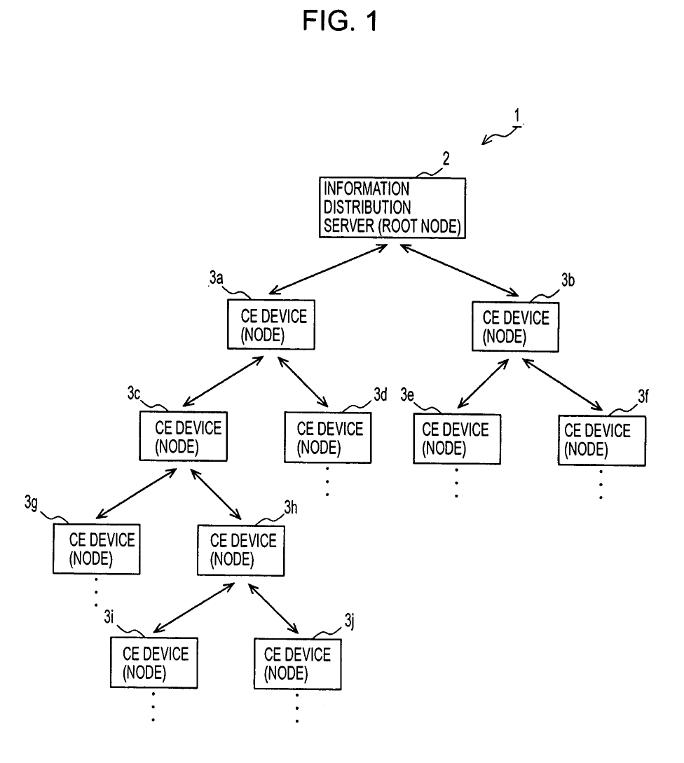

FIG. 1 shows an example of the network structure of an information distribution system 1 according to the embodiment of the present invention.

The information distribution system 1 has a tree structure. An information distribution server 2 is placed in a root node. CE devices 3a to 3j and other CE devices are placed in nodes below the root node.

The information distribution system 1 includes, for example, the Internet, a local-area network (LAN), or a wide-area network (WAN).

When there is no need to distinguish among the CE devices 3a to 3j and the other CE devices serving as nodes below the CE devices 3a to 3j, all the CE devices are, hereinafter, simply referred to as CE devices 3.

In addition, the security level of communication between nodes is increased by using a technology, such as secure sockets layer (SSL) encryption.

The information distribution server 2 distributes digital information to the CE devices 3. The information distribution server 2 is always connected to the CE devices 3a and 3b serving as nodes immediately below the information distribution server 2.

Although only the two CE devices 3 are connected to the information distribution server 2 in FIG. 1, the information distribution server 2 may be connected to more CE devices as long as they can be connected to the information distribution server 2.

Digital information distributed from the information distribution server 2 includes, for example, software applications, such as firmware, an operating system (OS), a kernel, middleware, application software, and correction software; application data used by software applications, such as map information, license data, dictionary data, and share data; content, which is one type of application data and may be copyrighted works, such as movie content, music content, and game content; and upgrades and revisions of such content.

The CE devices 3 are terminal devices. The CE devices 3 acquire digital information from the information distribution server 2 and use the acquired digital information.

The CE devices 3 are, for example, audio-visual devices (including television receivers, recording devices, and stereos), game devices, personal computers, portable information terminals, microwave ovens, washing machines, or air conditioners.

Each CE device 3 is always connected to a CE device 3 serving as the node immediately above (however, the CE devices 3a and 3b are connected to the information distribution server 2) and to a CE device 3 serving as a node immediately below via connection ports.

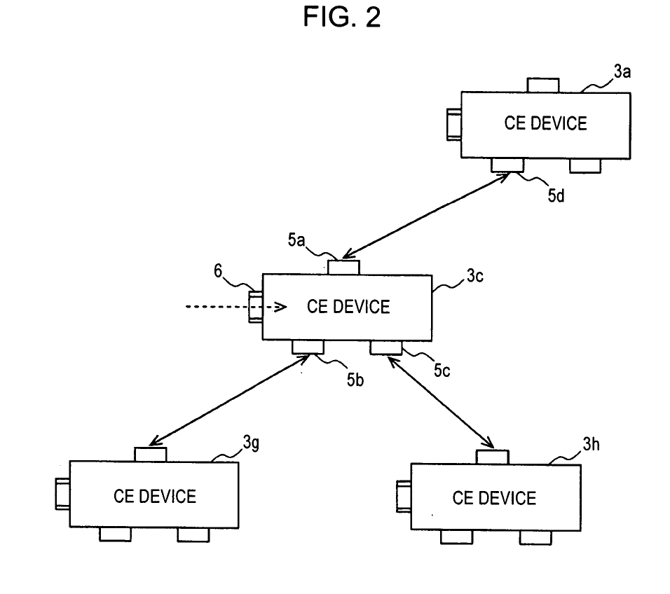

FIG. 2 is an illustration for explaining ports provided in each of the CE devices 3.

Each of the CE devices 3 includes a connection port and a listening port.

The connection port connects each of the CE devices 3 to the information distribution system 1 to allow each of the CE devices 3 to function as a node. The connection port is used for sending and receiving data information and digital information.

The connection port is a connection section to connect to a CE device (or the information distribution server 2) so as to always perform bidirectional communication. The information distribution server 2 also includes a similar connection section.

Connection information (an IP address and the port number of a connection port) to a node immediately below is referred to as a downlink, and connection information to a node immediately above is referred to as an uplink.

The listening port is an access section. The listening port receives access from outside the information distribution system 1.

As described below, the listening port is used, for example, for receiving access from a new CE device that desires to be connected to the information distribution system 1.

In the example shown in FIG. 2, the CE device 3c includes connection ports 5a to 5c and a listening port 6.

The CE device 3c always connects the connection port 5a to a connection port 5d of the CE device 3a. Thus, the CE device 3c serves as a node immediately below the CE device 3a.

In addition, the CE device 3c always connects the connection ports 5b and 5c to connection ports of the CE devices 3g and 3h. Thus, the CE devices 3g and 3h serve as nodes immediately below the CE device 3c.

Although only the CE devices 3g and 3h serve as nodes immediately below the CE device 3c in FIG. 2, the CE device 3c may be connected to more CE devices as long as they can be connected to the CE device 3c.

In addition, since the information distribution system 1 has such a tree structure, only one connection port to be connected to the node immediately above is provided for each CE device.

As described below, connection ports are dynamically set when the CE devices 3 are added to the information distribution system 1.

The listening port 6 is used, for example, for receiving a new CE device 3 to be connected to the information distribution system 1.

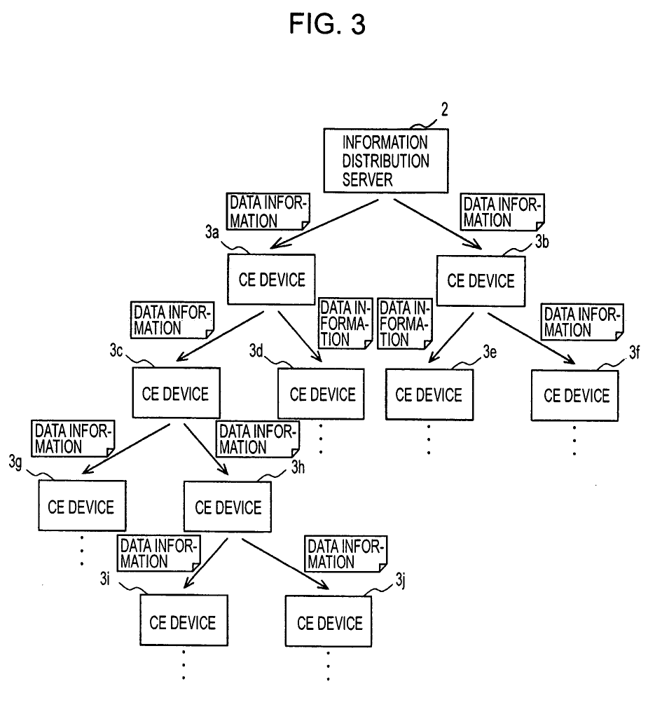

Distribution of data information is described next with reference to FIG. 3.

The information distribution server 2 regularly sends the CE devices 3a and 3b, which serve as the nodes immediately below, data information on digital information to be distributed.

The CE devices 3a and 3b acquire the data information sent from the information distribution server 2, and send the data information to the CE devices 3c and 3d and the CE devices 3e and 3f, which serve as nodes immediately below the CE devices 3a and 3b, respectively.

Then, acquisition and transfer of the data information from a CE device 3 serving as a node immediately above to a CE device 3 serving as a node immediately below is repeated until the data information is sent to a CE device serving as an end node of the tree structure.

Accordingly, the data information can be distributed to all the CE devices 3 constituting the information distribution system 1.

Data information includes an identifier and an issue date of digital information that can be distributed from the information distribution server 2, detail information of the digital information, a digital signature, and the like. The data information includes a list of distributable digital information.

Accordingly, the information distribution server 2 includes a list sending section for sending digital information to a CE device 3 immediately below.

In addition, each of the CE devices 3 includes a list receiving section for receiving data information from the node immediately above and a list sending section for sending digital information to a node immediately below.

Here, the digital information identifier is ID information for identifying unique digital information, and the issue date represents the date when the digital information is issued.

The detail information of the digital information is detailed information of the digital information to be distributed, such as a file size, an identifier of a supported device type of CE device to which the digital information is to be distributed, and a version. The digital signature is signature information for checking whether or not the digital information is altered.

Each of the CE devices 3 determines whether or not necessary digital information is included in the digital information to be distributed from the information distribution server 2 in accordance with the data information distributed from the information distribution server 2.

Alternatively, each of the CE devices 3 may present to a user a list of digital information that can be downloaded from the information distribution server 2, so that the user can select digital information to be downloaded.

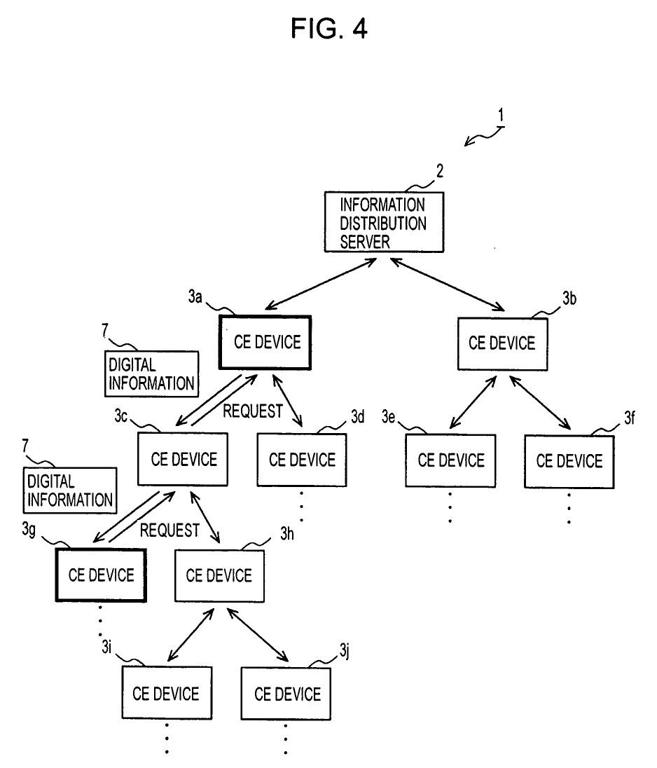

Distribution of digital information is described next with reference to FIG. 4.

In this example, the CE device 3g requires digital information 7, and the CE device 3a stores the digital information 7.

The CE device 3g determines, in accordance with data information distributed from the information distribution server 2, that the digital information 7 needs to be downloaded.

Then, the CE device 3g requires the CE device 3c serving as the node immediately above to send the digital information 7.

The CE device 3c receives the request from the CE device 3g to send the digital information 7, and determines whether or not the CE device 3c stores the digital information 7 by searching a storage medium of the CE device 3c.

If the CE device 3c stores the digital information 7, the CE device 3c sends the digital information 7 to the CE device 3g, and ends processing of distributing the digital information. However, in this example, the CE device 3c does not store the digital information 7.

In this case, the CE device 3c requires the CE device 3a, which serves as the node immediately above the CE device 3c, to send the digital information 7.

The CE device 3a receives the request from the CE device 3c to send the digital information 7, and determines whether or not the CE device 3a stores the digital information 7 by searching a storage medium of the CE device 3a.

Since the CE device 3a stores the digital information 7, the CE device 3a reads the digital information 7, and sends the digital information 7 to the CE device 3c, which transfers to the CE device 3a the request for the digital information 7.

After receiving the digital information 7 from the CE device 3a, the CE device 3c transfers the digital information 7 to the CE device 3g, which originally requires the digital information 7.

The CE device 3g receives the digital information 7 from the CE device 3c, and stores the digital information 7 in a storage medium (information storage section).

Accordingly, each of the CE devices 3 includes a request reception section for receiving a request from a node immediately below to send digital information and an information request section for requiring a node immediately above to send the digital information.

In addition, each of the CE devices 3 includes an information sending section for sending the digital information to a node immediately below when the digital information is stored in an information storage section and for sending the digital information sent from a node immediately above to a node immediately below when the digital information is not stored in the information storage section.

As described above, if a node located in a path to the root node (the information distribution server 2) stores desired digital information, the CE device 3g can download the digital information without accessing the information distribution server 2.

If the CE device 3a does not store the digital information 7, the CE device 3a acquires the digital information 7 from the information distribution server 2, which serves as the node immediately above the CE device 3a, and sends the digital information 7 to the CE device 3c.

As described above, the information distribution server 2 includes a request reception section for receiving a request from a node immediately below to send digital information included in data information and an information sending section for sending the required digital information to the node immediately below.

Furthermore, since digital information may be distributed in response to another request from another CE device 3, if a CE device 3 that transfers the digital information has a sufficient storage capacity, the CE device 3 stores the digital information when transferring the digital information.

Thus, for example, in a case where the CE device 3c stores the digital information 7 when transferring the digital information 7, if a CE device 3 constituting a sub-tree of the CE device 3h and lower nodes requires the digital information 7, the CE device 3c is capable of providing the digital information 7.

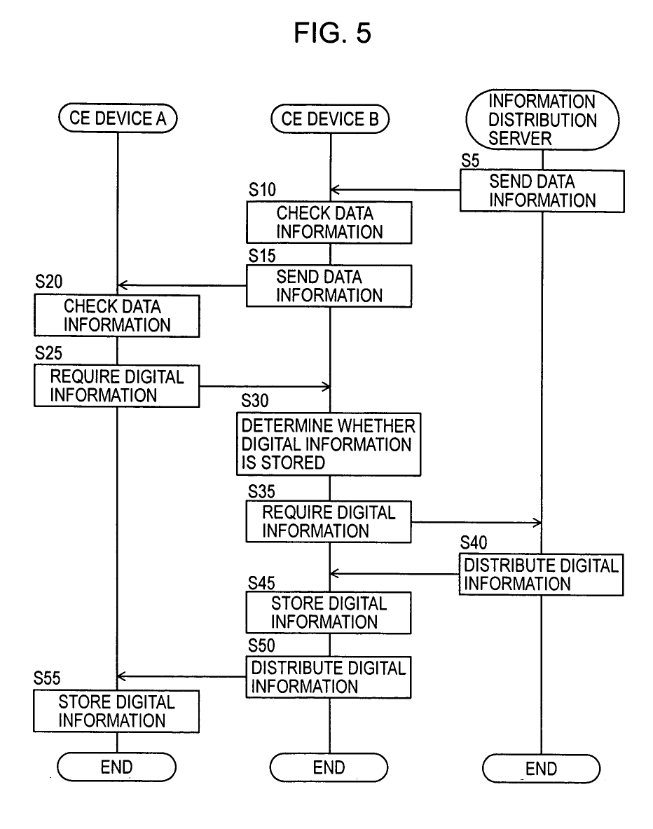

A process for distributing digital information from the information distribution system 1 to the CE devices 3 will be described with reference to the flowchart shown in FIG. 5.

Here, a CE device B serves as a node immediately below the information distribution server 2, and a CE device A serves as a node immediately below the CE device B. The CE device A requires digital information.

The information distribution server 2 regularly sends data information including a list of distributable digital information to the CE device B, which serves as the node immediately below the information distribution server 2 (step S5).

The data information is distributed to a CE device serving as an end node of the tree structure via connection between connection ports of the CE devices 3.

The CE device B receives the data information from the information distribution server 2, and checks the content of the data information (step S10).

In this processing, the CE device B determines whether or not digital information to be downloaded from the information distribution server 2 exists. In this example, digital information to be downloaded from the information distribution server 2 does not exist.

The CE device B sends the data information received from the information distribution server 2 to the CE device A, which serves as the node immediately below the CE device B (step S15).

The CE device A receives the data information from the CE device B, and checks the content of the data information (step S20).

In this example, digital information to be downloaded from the information distribution server 2 to the CE device A is included in the list in the data information.

The CE device A requires the CE device B to send the digital information (step S25).

For example, in this requiring processing, the CE device A sends a digital information identifier of the digital information to the CE device B.

The CE device B receives the request from the CE device A to send the digital information, and determines whether or not the CE device B stores the digital information (step S30).

If the CE device B stores the digital information, the CE device B sends the digital information to the CE device A. However, in this example, the CE device B does not store the digital information.

Since the CE device B does not store the digital information, the CE device B requires the node immediately above, that is, the information distribution server 2, to send the digital information (step S35).

The information distribution server 2 receives the request from the CE device B to send the digital information, and distributes the digital information to the CE device B (step S40).

The CE device B receives the digital information from the information distribution server 2, and stores the digital information (step S45). However, if the CE device B does not have a sufficient storage capacity, the CE device B does not store the digital information.

Then, the CE device B distributes the digital information received from the information distribution server 2 to the CE device A (step S50).

The CE device A receives the digital information from the CE device B, and stores the digital information (step S55).

As described above, the information distribution system 1 is capable of distributing the data information to all the nodes by causing each node to transfer the data information to a node immediately below.

If a node requires digital information, the request is transferred to a node storing the digital information via the connection between nodes, and the digital information is distributed to the originally requesting node by tracing back the connection between the nodes.

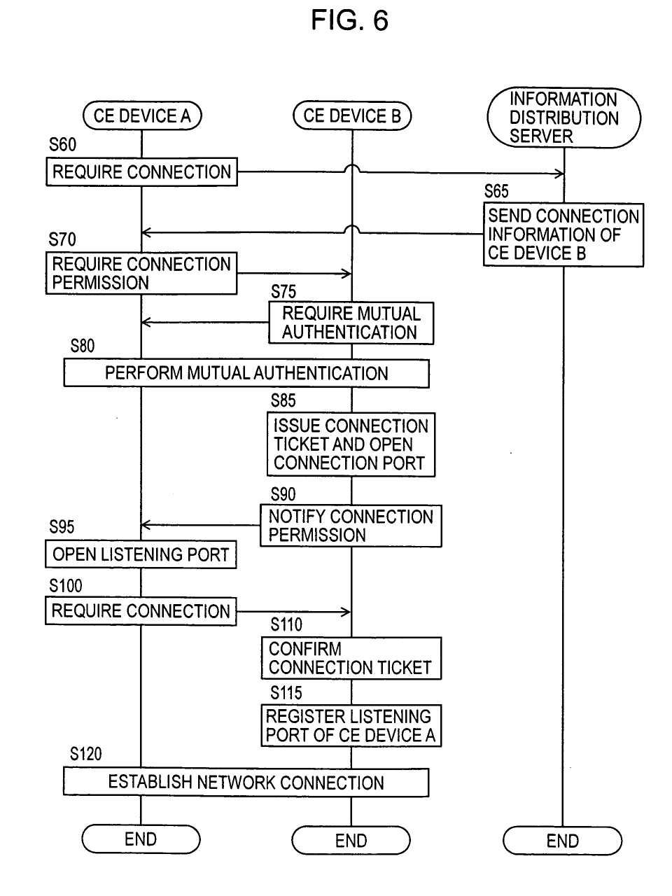

A process for connecting a new CE device 3 to the information distribution system 1 and causing the new CE device 3 to serve as a new node is described next with reference to the flowchart shown in FIG. 6.

Here, the CE device A is not connected to the information distribution system 1, and the CE device B serves as a node immediately below the information distribution server 2.

The CE device A accesses the information distribution server 2, and requires the information distribution server 2 to connect the CE device A to the information distribution system 1 (step S60).

The CE device A stores, in advance, access information, such as uniform resource locators (URL) and an IP address, on access to the information distribution server 2. The CE device A accesses the information distribution server 2 using such information.

After being accessed by the CE device A, the information distribution server 2 sends an IP address and the port number of a listening port of the CE device B to the CE device A, and introduces the CE device B (step S65).

The IP address and the port number of the CE device B constitute access information on access to the CE device B. The information distribution server 2 stores the access information on the CE device 3 serving as the node immediately below the information distribution server 2.

As described above, the information distribution server 2 includes an access information request reception section for receiving a request from a CE device 3 to send access information and an access information sending section for sending the access information to the CE device 3.

The CE device A receives the access information from the information distribution server 2 via an access information receiving section, and accesses the listening port of the CE device B. Then, the CE device A requires permission for connection with a connection port of the CE device B (step S70).

After receiving the connection permission request from the CE device A, the CE device B checks the number of nodes currently connected to the CE device B, and determines whether or not the number of connected nodes reaches an upper limit. If the number of connected nodes does not reach the upper limit, the CE device B requires the CE device A to perform mutual authentication (step S75).

“Mutual authentication” means that the CE devices A and B perform device authentication with each other.

If the number of connected nodes reaches the upper limit, the CE device B sends to the CE device A access information on a CE device 3 serving as a node immediately below the CE device B, and introduces the CE device 3 immediately below the CE device B to the CE device A.

As described above, each CE device 3 constituting the information distribution system 1 stores an IP address and the port number of a listening port of a CE device 3 serving as a node immediately below.

Subsequently, introduction is repeated until a CE device 3 whose number of connected nodes does not reach the upper limit is found. The CE device A sends a connection request to the CE device 3 whose number of connected nodes does not reach the upper limit.

In this example, the number of connected nodes of the CE device B does not reach the upper limit. The CE device A receives a request from the CE device B to perform mutual authentication, and performs mutual authentication (step S80). Accordingly, each of the CE devices A and B has a mutual authentication section.

If both the CE devices A and B determine that they are valid CE devices 3 in accordance with the result of mutual authentication, the CE device B issues a connection ticket and opens a connection port so that the CE device A can be connected to the connection port (step S85).

The connection ticket is a temporarily valid random number issued by a requested CE device 3 for a requesting CE device 3 after performing mutual authentication. The connection ticket is generated for each operation of mutual authentication. Even if a used connection ticket leaks to an invalid device, the used ticket cannot be used.

Then, the CE device B sends the connection ticket and the port number of the connection port to the CE device A, and notifies connection permission (step S90).

The CE device A receives such information from the CE device B, and opens a listening port (step S95).

The CE device A opens the listening port for receiving access from another CE device 3 after starting to serve as a node of the information distribution system 1.

The CE device A sends the port number of the listening port and the connection ticket received from the CE device B to the CE device B, and requires connection with the connection port of the CE device B (step S100).

The CE device B receives the connection ticket from the CE device A, and confirms that the received connection ticket is equal to the connection ticket that the CE device B sent to the CE device A in step S90 (step S 110).

If the received connection ticket is not equal to the connection ticket the CE device B sent to the CE device A, the CE device B does not receive access from the CE device A. Since an invalid device does not have a valid connection ticket, the requested CE device 3 is capable of confirming that the requesting CE device 3 is valid by verifying the connection ticket.

After confirming the connection ticket, the CE device B stores and registers the port number of the listening port received from the CE device A and the IP address of the CE device B (step S115).

Then, the CE device B receives the connection request from the CE device A, and establishes network connection using the connection port (step S120).

As described above, the CE device 3 whose number of connected nodes does not reach the upper limit is introduced to the CE device A that is not added to the information distribution system 1, and after mutual authentication is achieved, the CE device A is connected to the CE device 3 and thus comes to serve as a node of the information distribution system 1.

Although an invalid device can externally access a listening port, which is always open, the subsequent transmission and reception is interrupted unless mutual authentication is achieved, thus ensuring the security.

In addition, since any number can be set to the listening port and the number of the listening port is known only by a node immediately above, it is unlikely to be attacked by the invalid device.

In contrast, since a connection port is used for sending and receiving digital information, it is desirable that only a valid device that achieves mutual authentication be permitted to be connected.

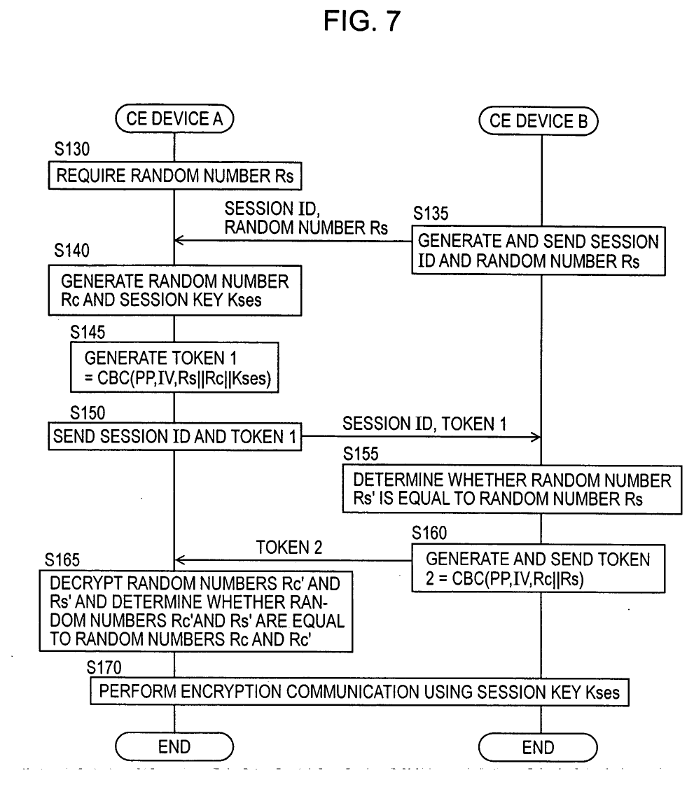

A process for performing mutual authentication between the CE devices A and B in step S80 in FIG. 6 is described next with reference to the flowchart shown in FIG. 7.

Here, the CE devices A and B share, as secret information for performing mutual authentication, a passphrase PP (the number of characters of the passphrase PP is larger than that of a password) and an initial value IV used for encryption.

The CE device A requires the CE device B to send a random number Rs (step S130).

After receiving the request, the CE device B generates a session ID and a 128-bit random number Rs, and sends the session ID and the random number Rs to the CE device A (step S135). The CE device B stores the combination of the random number Rs and the session ID.

Here, the session ID is session identification information used for maintaining a session.

The CE device A stores the session ID and the random number Rs received from the CE device B, and generates a 128-bit random number Rc and a session key Kses (step S140).

Then, the CE device A generates a token 1 represented by condition (1), token 1=CBC(PP,IV,RS∥Rc∥Kses) (step S145).

In this embodiment, the advanced encryption standard 128-bit key version (AES128) algorithm is used as an example of encryption.

Based on this algorithm, information (a message) is divided into 128-bit blocks (message blocks). Each block is encrypted using a 128-bit common key, and the encrypted block is sent and received.

Although various modes are available for the AES128 algorithm, the AES128-cipher block chaining (AES128-CBC) mode is used in this embodiment.

In the AES128-CBC mode, when each message block is encrypted using a common key, the message block is encrypted using an encryption result of the immediately preceding message block.

Thus, since different encryption information can be acquired from a message block, high security can be achieved.

In this embodiment, encryption information based on the AES128-CBC mode is represented by condition (2), CBC(PP,IV,msg1∥mesg2∥ . . . ∥msgn).

Condition (2) means that each of the 128-bit message blocks msg1, msg2, . . . msgn is encrypted using a 128-bit common key (here, a passphrase PP).

Since no message block exists before the head message block msg1, an initial value (initial vector) IV is provided to the message block msg1.

After generating the token 1 in accordance with CBC encryption, the CE device A sends the session ID received from the CE device B and the generated token 1 to the CE device B (step S150).

The CE device B receives such information from the CE device A. First, the CE device B identifies a session to which the received information belongs in accordance with the session ID. Thus, in accordance with the combination of the session ID and the random number Rs stored in advance, the random number Rs issued for the CE device A is identified.

Then, the CE device B decrypts the token 1 using the passphrase PP and the initial value IV used for mutual authentication that are included in a license, and acquires a random number Rs′, a random number Rc′, and a session key Kses′.

Hereinafter, information acquired by decryption is represented, for example, by “Rs′” using a prime symbol“′”.

In addition, the CE device B knows that information “Rs∥Rc∥Kses” acquired by decrypting the token 1 is information in which the random number Rs, the random number Rc, and the session key Kses are connected in that order and that each of the random number Rs, the random number Rc, and the session key Kses has 128 bits. Thus, the random number Rs′, the random number Rc′, and the session key Kses′ can be extracted from the information “Rs∥Rc∥Kses” acquired by decrypting the token 1.

Then, the CE device B determines whether or not the acquired random number Rs′ is equal to the random number Rs generated in advance (step S155).

If the random number Rs′ is equal to the random number Rs, it is determined that the CE device A stores the passphrase PP. Thus, it is determined that the session key Kses′ is equal to the session key Kses, that is, the session key Kses′ is recognized as the valid session key issued by the CE device A.

If session key Kses′ is not equal to the session key Kses, the CE device B determines that the CE device A does not store the passphrase PP. Thus, device authentication is not achieved, and the device authentication processing ends.

If the CE device B determines that the random number Rs′ is equal to the random number Rs, the CE device B generates a token 2 represented by condition (3), token 2=CBC(PP,IV,Rc∥Rs), and sends the token 2 to the CE device A (step S160).

After receiving the token 2 from the CE device B, the CE device A decrypts the token 2 using the passphrase PP and the initial value IV and acquires “Rc∥Rs”.

The CE device A knows that this information is obtained by connecting the 128-bit information Rc′ and Rs′ in that order. Thus, the random numbers Rc′ and Rs′ can be acquired from the result obtained by decrypting the token 2.

Then, the CE device A determines whether or not the acquired random number Rc′ is equal to the random number Rc generated in advance.

If the random number Rc′ is equal to the random number Rc, it is determined that the CE device B stores the passphrase PP. Thus, the device authentication processing proceeds.

If the random number Rc′ is not equal to the random number Rc, the CE device A determines that the CE device B does not store the passphrase PP. Thus, device authentication is not achieved, and the device authentication processing ends.

In this embodiment, in order to achieve a higher security level, it is also determined whether or not the random number Rs′ is equal to the random number Rs sent from the CE device B in step S160 (step S165).

After the CE device A confirms that the random number Rc′ is equal to the random number Rc and that the random number Rs′ is equal to the random number Rs, the CE devices A and B start encryption communication using the session key Kses (step S 170).

The CE devices A and B are capable of sending and receiving a connection ticket and establishing network connection via the encryption communication using the session key Kses.

In accordance with the foregoing procedure, the CE devices A and B are capable of performing mutual authentication using shared secret information (the passphrase PP and the initial value IV). In addition, the CE devices A and B are capable of sharing the session key Kses.

By performing encryption communication using the session key Kses after mutual authentication is achieved, the number of encryption communication operations using the passphrase PP can be reduced to the minimum, thus increasing the security level.

Although the CE device A generates the session key Kses and supplies the session key Kses to the CE device B in the foregoing procedure, the CE device B may generate the session key Kses and may supply the session key Kses to the CE device A.

In this case, the CE device A does not generate the session key Kses in step S140, and the token 1 generated in step S145 does not include the session key Kses.

Instead, after determining that the random number Rs′ is equal to the random number Rs in step S155, the CE device B generates the session key Kses and sends the token 2 including the session key Kses to the CE device A in step S160.

The CE device A decrypts the token 2 to acquire the session Kses.

In addition, a token 2 represented by condition (4), token 2=CBC(PP,IV,Rc∥Rs∥Kses), including the session key Kses may be generated in step S160 in FIG. 7.

With this arrangement, the amount of information of the token 2 increases, and this makes cryptanalysis by an invalid device difficult.

Although a case where CE devices perform mutual authentication with each other has been described with reference to the flowchart shown in FIG. 7, since the information distribution server 2 also has a function to perform mutual authentication, mutual authentication can be performed between the CE device 3 and the information distribution server 2.

Thus, in order to connect a CE device 3 to the information distribution server 2 as a node immediately below the information distribution server 2, mutual authentication is performed between the CE device 3 and the information distribution server 2. If authentication is achieved, the CE device 3 is capable of being connected to the information distribution server 2 as the node immediately below the information distribution server 2.

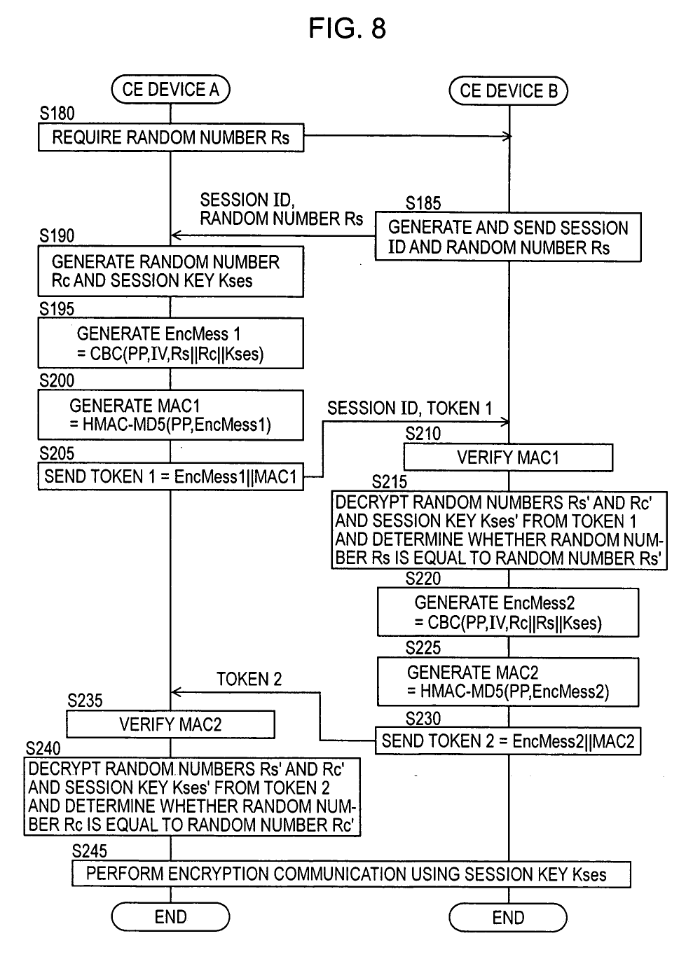

The AES128 algorithm also has the AES128-CBC-message authentication code (hereinafter, simply referred to as “MAC”) mode. An example of a process for performing mutual authentication using MAC is described next with reference to the flowchart shown in FIG. 8.

As described below, the MAC is used as confirmation information for confirming whether or not encryption information based on AES128-CBC encryption is altered in the process of communication.

First, the CE device A requires the CE device B to send a random number Rs (step S180).

After receiving the request, the CE device B generates a session ID and a 128-bit random number Rs, and sends the session ID and the random number Rs to the CE device A (step S185). The CE device B stores the combination of the random number Rs and the session ID.

The CE device A stores the session ID and the random number Rs received from the CE device B, and generates a 128-bit random number Rc and a session key Kses (step S190).

Then, the CE device A generates an encryption message EncMess1 (encryption message 1) represented by condition (5), EncMess1=CBC(PP,IV,Rs∥Rc∥Kses) (step S195).

Then, the CE device A generates a MAC1 represented by condition (6), MAC1=HMAC-MD5(PP,EncMess1) (step S200).

Here, “hash message authentication code-message digest 5 (HMAC-MD5)” is one type of hash function, and the MAC1 is the final block of the encryption message EncMess1 encrypted based on the HMAC-MD5 using the passphrase PP.

Then, the CE device A generates a token 1 represented by condition (7), token 1=EncMess1∥MAC1, by connecting the encryption message EncMess1 and the MAC1 in that order, and sends the token 1 and the session ID to the CE device B (step S205).

The CE device B receives the token 1 from the CE device A, and acquires the encryption message EncMess1 and the MAC1 from the token 1.

Then, the CE device B verifies the MAC1 (step S210). In other words, the encryption message EncMess1 extracted from the token 1 is encrypted based on the HMAC-MD5 using the passphrase PP. Then, it is determined whether or not the final block of information acquired by the encryption is equal to the MAC1.

The CE device B is capable of confirming that the encryption message EncMess1 is valid (in other words, the encryption message EncMess1 is not altered) by confirming that the final block of the information acquired by the encryption is equal to the MAC1.

If the final block of the information acquired by the encryption is equal to the MAC1, the authentication processing proceeds. If the final block of the information acquired by the encryption is not equal to the MAC1, authentication is not achieved, and the processing ends.

After verifying the MAC1, the CE device B decrypts the random number Rs′, the random number Rc′, and the session key Kses′ from the encryption message EncMess1 using the passphrase PP.

Then, it is determined whether or not the random number Rs sent to the CE device A in advance is equal to the random number Rs′ decrypted from the encryption message EncMess1 (step S215).

If the random number Rs is equal to the random number Rs′, it is confirmed that the CE device A stores the passphrase PP used for performing mutual authentication and that the session key Kses′ is a valid session key Kses.

If the random numbers Rs and Rs′ are not equal to each other, authentication is not achieved, and the processing ends.

Then, the CE device B generates an encryption message EncMess2 represented by condition (8), EncMess2=CBC(PP,IV,Rc∥Rs∥Kses) (step S220).

Then, the CE device B generates a MAC2 represented by condition (9), MAC2=HMAC-MD5(PP,EncMess2) (step S225).

Then, the CE device B generates a token 2 represented by condition (10), token 2=EncMess2∥MAC2, by connecting the encryption message EncMess2 and the MAC2 in that order, and sends the token 2 to the CE device A (step S230).

The CE device A receives the token 2 from the CE device B, and acquires the encryption message EncMess 2 and the MAC2 from the token 2.

Then, the CE device A verifies the MAC2 (step S235). In other words, the encryption message EncMess2 extracted from the token 2 is encrypted based on the HMAC-MD5 using the passphrase PP. Then, it is determined whether or not the final block of information acquired by the encryption is equal to the MAC2.

The CE device A is capable of confirming that the encryption message EncMess2 is valid by confirming that the final bock of the information acquired by the encryption is equal to the MAC2.

If the final block of the information acquired by the encryption is equal to the MAC2, the authentication processing proceeds. If the final block of the information acquired by the encryption is not equal to the MAC2, authentication is not achieved, and the processing ends.

After verifying the MAC2, the CE device A decrypts the random number Rc′, the random number Rs′, and the session key Kses′ from the encryption message EncMess2 using the passphrase PP.

Then, it is determined whether or not the random number Rc sent to the CE device A in advance is equal to the random number Rc′ decrypted from the EncMess2 (step S240).

If the random number Rc′ is equal to the random number Rc, the random number Rs′ is equal to the random number Rs, and the session key Kses′ is equal to the session key Kses, it is determined that the CE device A stores the passphrase PP.

Accordingly, after achieving mutual authentication, the CE devices A and B perform encryption communication using the session key Kses (step S245).

Processing performed when a failure occurs in a CE device 3 constituting the information distribution system 1 and the CE device 3 is disconnected from the network will be described.

For example, the CE device 3 connected to the information distribution system 1 is used at home and may be disconnected when not expected, due to interruption of electric service, power disconnection, network trouble, or the like.

When the CE device 3 is disconnected from the information distribution system 1, CE devices 3 connected lower than the disconnected CE device 3 are also disconnected from the information distribution system 1.

In this case, a CE device 3 serving as a node immediately below the disconnected CE device 3 sends a re-connection request to the information distribution server 2, as in a case where the CE device 3 sends a new connection request, while maintaining the connection state of the lower nodes.

Then, a proper node is introduced, and re-connection with a CE device 3 serving as the proper node is achieved. Thus, disconnected CE devices are capable of being connected to the information distribution system 1 by a single re-connection operation.

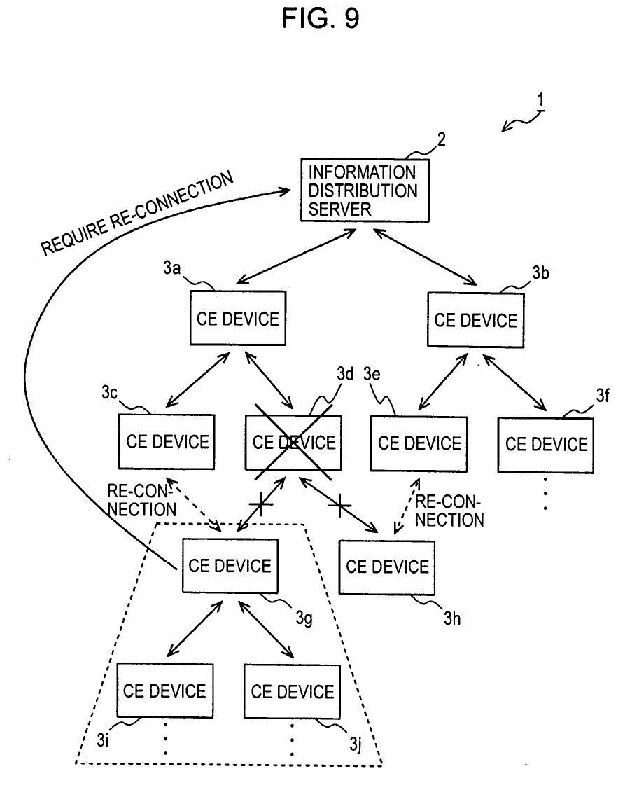

For example, as shown in FIG. 9, the CE device 3d is disconnected from the information distribution system 1.

In this case, the CE device 3h and a sub-tree constituted by the CE device 3g and the subsequent CE devices that are connected below the CE device 3d are disconnected from the information distribution system 1.

In this case, the CE device 3g sends a re-connection request to the information distribution server 2 while maintaining connection with the CE devices 3i, 3j, and so on serving as lower nodes.

For example, the information distribution server 2 introduces the CE device 3a to the CE device 3g, and the CE device 3a introduces the CE device 3c to the CE device 3g. Then, the CE device 3g is connected to the CE device 3c.

The CE device 3h also sends a re-connection request to the information distribution server 2. The information distribution server 2 introduces the CE device 3b to the CE device 3h, and the CE device 3b introduces the CE device 3e to the CE device 3h. Then, the CE device 3h is connected to the CE device 3e.

As described above, when a failure occurs, a sub-tree is connected to a node that operates normally while the connection state of the sub-tree is maintained. Thus, a quick recovery can be achieved.

Acquisition of digital information in the middle of processing will be described.

Although, generally, nodes are always connected to each other in the information distribution system 1, disconnection may occur due to the power off of a CE device 3 or a failure occurring in the information distribution system 1. In addition, a time when a user purchases a CE device 3 and connects the CE device 3 to the information distribution system 1 may be different from a time when the user purchases another CE device 3 and connects the other CE device 3 to the information distribution system 1.

Since digital information is distributed from the information distribution server 2, the digital information is not distributed to a CE device 3 that is not connected to the information distribution system 1 when the information distribution server 2 is distributing the digital information.

In order to prevent such a situation, for example, the processing described below can be performed.

In other words, when a CE device 3 is connected or re-connected to the information distribution system 1, the CE device 3 sends to a node immediately above an identifier and an issue date of digital information stored in the CE device 3.

The node immediately above acquires the identifier and the issue date, and compares the acquired identifier and issue date with an identifier and an issue date of digital information stored in the node.

If the node detects that the digital information stored in the CE device 3 immediately below is not the latest digital information, the node sends the CE device 3 a difference between the latest digital information and the digital information stored in the CE device 3.

The CE device 3 receives the difference, and updates the stored digital information.

By performing the foregoing processing, each of the CE devices 3 connected to the information distribution system 1 keeps the latest digital information.

The information distribution system 1 according to a modification of the present invention will be described.

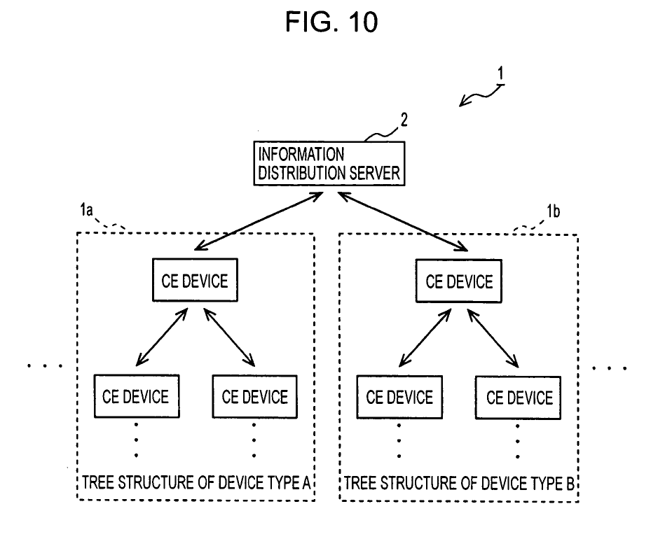

As shown in FIG. 10, the information distribution system 1 may include a plurality of information distribution system sections 1a, 1b, and so on, provided with the common information distribution server 2 serving as a root node.

If a plurality of types of CE devices 3 exists in the information distribution system 1, CE devices 3 of the same type are likely to require same digital information. Thus, constituting each information distribution system section by the CE devices 3 of the same type increases the efficiency of distribution of digital information.

In the example shown in FIG. 10, the tree structure of a device type A constitutes the information distribution system section 1a, and the tree structure of a device type B constitutes the information distribution system section 1b.

Such a plurality of information distribution system sections is connected to the common information distribution server 2.

As described above, in a case where a tree structure is formed for each device type and each tree structure is connected to the common information distribution server 2, when a CE device 3 sends a connection request to the information distribution server 2, the information distribution server 2 determines the device type of the CE device 3 and assigns the CE device 3 to a proper tree structure.

In order to assign the CE device 3 depending on the device type, a device type identifier (device type information) is embedded in the CE device 3 in advance, and the device type identifier is sent to the information distribution server 2 when the connection request is sent.

The information distribution server 2 receives the device type identifier from the CE device 3, and determines the device type of the CE device 3. Thus, the information distribution server 2 is capable of introducing a proper tree structure.

As described above, the information distribution server 2 includes a device type information acquisition section for acquiring device type information from the CE device 3 and an access information (access information on access to a node connected to the information distribution server 2 in an introduced tree structure) selection section for selecting access information in accordance with the device type information.

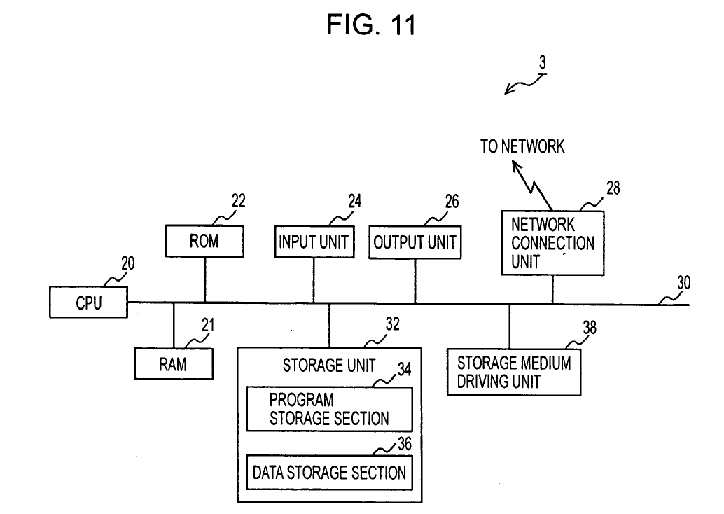

The hardware structure of each of the CE devices 3 will be described with reference to FIG. 11.

In this example, the CE device 3 is an audio-visual device having a digital versatile disk (DVD) playback function and the like.

In the CE device 3, a read-only memory (ROM) 22, a random-access memory (RAM) 21, an input unit 24, an output unit 26, a storage unit 32, a network connection unit 28, a storage medium driving unit 38, and the like are connected to a central processing unit (CPU) 20 via a bus line 30.

The CPU 20 is a central processing unit for loading a program stored in the ROM 22, the storage unit 32, or the like and executing the program.

In this modification, the CPU 20 executes a management program stored in the storage unit 32. The CPU 20 also implements a function to manage the CE device 3 in the information distribution system 1, such as receiving, transferring, and checking data information, receiving and transferring digital information, and sending a connection request and connecting to the information distribution system 1. In addition, the CPU 20 implements a function to provide a user with a service, such as playback of movie content.

The ROM 22 is a nonvolatile read-only memory storing, for example, various programs, data, and parameters for performing the basic control of the CPU 20. A program stored in the ROM 22 is executed, for example, when the CE device 3 starts.

The RAM 21 is a readable and writable memory used by the CPU 20 as a working memory. For example, the RAM 21 is used, for example, when digital information is received or when movie content is played back.

The input unit 24 includes operation terminals, such as an operation panel and a remote controller. The input unit 24 receives a user operation performed for the CE device 3.

The output unit 26 includes, for example, a display for displaying played back movie content and a speaker for outputting sound.

The network connection unit 28 connects the CE device 3 to the information distribution system 1.

The storage unit 32 includes, for example, a hard disk or a semiconductor memory. The CPU 20 accesses the storage unit 32 to read information and to write information.

The storage unit 32 includes a program storage section 34 storing various programs and a data storage section 36 storing various types of data.

An OS, a management program, and so on are installed in the program storage section 34.

The OS is a program implementing a basic function of the CE device 3, such as input and output of files and the entire control of the CE device 3.

The management program causes the CPU 20 to implement the function to manage the CE device 3 in the information distribution system 1, such as distributing data information and digital information in the information distribution system 1 and sending a connection request to the information distribution system 1.

The data storage section 36 stores digital information distributed from the information distribution server 2, secret information, such as the passphrase PP and the initial value IV, for performing mutual authentication, access information, such as an IP address and the port number of a listening port, on a CE device 3 serving as a node immediately below.

Although the hardware structure of the CE device 3 has been described, the hardware structure of the information distribution server 2 is basically similar to the hardware structure of the CE device 3.

The information distribution server 2 stores data information and digital information to be distributed to a CE device 3, access information on a CE device 3 serving as a node immediately below, and secret information for performing mutual authentication.

As described above, the information distribution system 1 has a tree structure in order to distribute digital information to CE devices 3 via a network.

The information distribution server 2 distributes data information including a list of distributable digital information to all the CE devices 3 via the network.

When referring to data information and determining that necessary digital information exists, the CE device 3 requires an adjacent connected CE device 3 to acquire the digital information. If the requested CE device 3 stores the digital information, the requested CE device 3 sends the digital information to the requesting CE device 3. If the requested CE device 3 does not store the digital information, the requested CE device 3 requires another adjacent CE device 3 to acquire the digital information. The request finally reaches the information distribution server 2, and the digital information is distributed from the information distribution server 2.

Since the number of transmission operations of sending the data information and the digital information performed by the information distribution server 2 is equal to the number of CE devices directly connected to the information distribution server 2, the number of transmission operations can be reduced.

Although a CE device 3 requires a CE device 3 serving as a node immediately above to send digital information and transfers digital information to a CE device 3 serving as a node immediately below in the foregoing embodiments, the CE device 3 may require a CE device 3 serving as a node immediately below to send digital information and may transfer digital information to a CE device 3 serving as a node immediately above.

For example, in FIG. 1, a digital information request issued by the CE device 3g may be transferred to the CE device 3j via the CE device 3c and the CE device 3h in that order, and the required digital information may be transferred by tracking back a path, in other words, transferred through a path from the CE device 3j to the CE device 3g via the CE device 3h and the CE device 3c in that order.

In other words, irrespective of the hierarchical relationship of the tree structure, data information and digital information may be transferred to an adjacent node.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information distribution system with a tree-structure network, the information distribution system comprising:
an information distribution server placed in a root node; and
terminal devices placed in nodes below the root node,
wherein bidirectional communication can be always performed between the nodes,
wherein when a terminal device sends a request for information to be distributed from the information distribution server, each of the terminal devices constituting the information distribution system transfers the request to an adjacent node, the request transfer being performed from the requesting terminal device to a storage node storing the information, and transfers to an adjacent node the information supplied from the storage node, the information transfer being performed from the storage node to the requesting terminal device, in response to the transferred request, and
wherein the requesting terminal device stores the transferred information.

2. A terminal device used in an information distribution system with a tree-structure network in which an information distribution server is placed in a root node and in which terminal devices are placed in nodes below the root node, the terminal device comprising:
connection means for connecting to a node immediately above and to a node immediately below so as to always perform bidirectional communication; and
information storage means for storing information distributed via the network.

3. The terminal device according to claim 2, further comprising:
list receiving means for receiving from the node immediately above, connected by the connection means, a list of information to be distributed from the information distribution server; and
list sending means for sending the received list to the node immediately below, connected by the connection means.

4. The terminal device according to claim 2, further comprising:
request reception means for receiving from the node immediately below, connected by the connection means, a request for information; and
information sending means for reading from the information storage means the information for which the request is received and for sending the read information to the node immediately below.

5. The terminal device according to claim 4, further comprising information request means for sending the request for the information to the node immediately above, connected by the connection means, when the information storage means does not store the information, wherein
the information sending means sends to the node immediately below the information sent from the node immediately above in response to the request.

6. The terminal device according to claim 2, further comprising:
access information acquisition means for acquiring access information for accessing another terminal device serving as a node; and
mutual authentication means for accessing the other terminal device using the acquired access information and for mutually performing device authentication with the other terminal device, wherein
after mutual authentication is performed, the connection means connects the terminal device, as a node immediately below the other terminal device, to the other terminal device.

7. The terminal device according to claim 6, wherein when the other terminal device serving as the node immediately above loses a node functionality, the access information acquisition means acquires the access information from the information distribution server.

8. The terminal device according to claim 2, further comprising mutual authentication means for receiving access from a terminal device that does not serve as a node and for mutually performing device authentication with the terminal device that does not serve as the node, wherein
after mutual authentication is performed, the connection means connects the terminal device, as a node immediately above the terminal device that does not serve as the node, to the terminal device that does not serve as the node.

9. The terminal device according to claim 8, wherein in a case where the number of currently connected nodes reaches an upper limit, the terminal device sends access information on access to a terminal device serving as the node immediately below to the terminal device that does not serve as the node when receiving access from the terminal device that does not serve as the node.

10. An information distribution server used in an information distribution system with a tree-structure network in which the information distribution server is placed in a root node and in which terminal devices are placed in nodes below the root node, the information distribution server comprising:
connection means for connecting to a terminal device serving as a node immediately below so as to always perform bidirectional communication;
list sending means for sending a list of information to be distributed via the network to the terminal device serving as the node immediately below;
request reception means for receiving a request for information included in the list from the terminal device serving as the node immediately below; and
information sending means for sending the information for which the request is received to the terminal device serving as the node immediately below.

11. The information distribution server according to claim 10, further comprising:
access information request reception means for receiving an access information request for access information from a terminal device that does not serve as a node; and
access information sending means for sending the access information on access to the terminal device serving as the node immediately below to the terminal device that does not serve as the node in response to the access information request.

12. The information distribution server according to claim 11, further comprising device type information acquisition means for acquiring device type information of the terminal device that does not serve as the node, wherein the access information sending means selects access information to be sent to the terminal device that does not serve as the node in accordance with the acquired device type information.

13. An information distribution method performed by a terminal device that is used in an information distribution system with a tree-structure network in which an information distribution server is placed in a root node and in which terminal devices are placed in nodes below the root node and that includes connection means for connecting to a node immediately above and to a node immediately below so as to always perform bidirectional communication, information storage means for storing information distributed via the network, request reception means, and information sending means, the information distribution method comprising:
receiving, by the request reception means, a request for information from the node immediately below, connected by the connection means; and
sending, by the information sending means, the information for which the request is received, which is read from the information storage means, to the node immediately below.

14. A terminal device connection method for connecting a terminal device that includes connection means for connecting to a node immediately above and to a node immediately below so as to always perform bidirectional communication and mutual authentication means to an information distribution system with a tree-structure network in which an information distribution server is placed in a root node and in which terminal devices are placed in nodes below the root node, the terminal device connection method comprising:
mutually performing, by the mutual authentication means, device authentication with a terminal device that does not serve as a node after receiving access from the terminal device that does not serve as the node; and
connecting, by the connection means, the terminal device, as a node immediately above the terminal device that does not serve as the node, to the terminal device that does not serve as the node after mutual authentication is performed.

15. An information distribution method performed by an information distribution server that is used in an information distribution system with a tree-structure network in which the information distribution server is placed in a root node and in which terminal devices are placed in nodes below the root node and that includes connection means for connecting to a terminal device serving as a node immediately below so as to always perform bidirectional communication, list sending means, request reception means, and information sending means, the information distribution method comprising:
sending, by the list sending means, a list of information to be distributed via the network to the terminal device serving as the node immediately below;
receiving, by the request reception means, a request for information included in the list from the terminal device serving as the node immediately below; and
sending, by the information sending means, the information for which the request is received to the terminal device serving as the node immediately below.

16. An information processing program product executed by a computer constituting a terminal device in an information distribution system with a tree-structure network in which an information distribution server is placed in a root node and in which terminal devices are placed in nodes below the root node, the information processing program product -comprising:
a connection function to connect to a node immediately above and to a node immediately below so as to always perform bidirectional communication; and
an information storage function to store information distributed via the network.

17. An information processing program product executed by a computer constituting an information distribution server in an information distribution system with a tree-structure network in which the information distribution server is placed in a root node and in which terminal devices are placed in nodes below the root node, the information processing program product comprising:
a connection function to connect to a terminal device serving as a node immediately below so as to always perform bidirectional communication;
a list sending function to send a list of information to be distributed via the network to the terminal device serving as the node immediately below;
a request reception function to receive a request for information included in the list from the terminal device serving as the node immediately below; and
an information sending function to send the information for which the request is received to the terminal device serving as the node immediately below.

18. A terminal device used in an information distribution system with a tree-structure network in which an information distribution server is placed in a root node and in which terminal devices are placed in nodes below the root node, the terminal device comprising:
a connection section connecting to a node immediately above and to a node immediately below so as to always perform bidirectional communication; and
an information storage section storing information distributed via the network.

19. An information distribution server used in an information distribution system with a tree-structure network in which the information distribution server is placed in a root node and in which terminal devices are placed in nodes below the root node, the information distribution server comprising:
a connection section connecting to a terminal device serving as a node immediately below so as to always perform bidirectional communication;
a list sending section sending a list of information to be distributed via the network to the terminal device serving as the node immediately below;
a request reception section receiving a request for information included in the list from the terminal device serving as the node immediately below; and
an information sending section sending the information for which the request is received to the terminal device serving as the node immediately below.
